(19) United States
(12) Patent Application Publication
(10) Pub. No.: US 2011/0131307 A1
(43) Pub. Date: Jun. 2, 2011

(54) METHOD AND NODE FOR APPLYING A POLICY TO A SESSION BASED ON A PREVIOUSLY PREDICTED SESSION STATE

(75) Inventors: Zouhair El Bazzal, Ville St-Laurent (CA); Yves Lemieux, Kirkland (CA)

(73) Assignee: TELEFONAKTIEBOLAGET LM ERICSSON (PUBL), Stockholm (SE)

(21) Appl. No.: 12/692,096

(22) Filed: Jan. 22, 2010

Related U.S. Application Data
(60) Provisional application No. 61/265,417, filed on Dec. 1, 2009.

(51) Int. Cl. G06F 15/173

(52) U.S. Cl. 709/223

(57) ABSTRACT

A method and a policy enforcement point are provided for applying policies to a session. An eventual state of the session is predicted in a prediction engine of a policy enforcement point. The predicted state is sent to a policy controller, which returns a policy for the predicted state. If the predicted state, or a similar state, is detected, the policy enforcement point applies the policy for the predicted state to the session.

### PRIORITY STATEMENT UNDER 35 U.S.C. S.119(e) & 37 C.F.R. S.1.78

This non-provisional patent application claims priority based upon the prior U.S. provisional patent application entitled “UE Performance Improvement Based on Policy Prediction While Enforcing SASN Actions”, application No. 61/265,417, filed on Dec. 1, 2009, in the names of Zouhair El Bazzal and Yves Lemieux.

### TECHNICAL FIELD

The present invention relates generally to the field of communications and, more specifically, to a method and a policy enforcement point for_applying a policy to a session based on a previously predicted session state.

### BACKGROUND

Recently introduced fourth generation (4G) mobile communications networks provide bandwidth and quality of service (QoS) capabilities to user terminals far beyond those of previous systems. Allocation of a share of a network capabilities to a given user terminal is made at least in part on the basis of policies that may relate to a subscriber profile, to network planning, and to general procedures established by a network operator. As a non-limiting example, policies may be related to a subscriber profile for a terminal user and to a cell or access point providing access to the terminal. A QoS profile and related bandwidth allocation may be optimal, or not, depending on whether the subscription profile is of a Gold, Silver or Bronze class. Also, the bandwidth and/or delay constraints may depend on whether or not the cell or access point is located in a high capacity zone of the network.

FIG. 1 is a prior art representation of an access and service network architecture. A network 100 provides to a user equipment (UE) 110 access to a service network 120. The network 100 comprises a radio access network 130 that further comprises one or more evolved node Bs (eNodeB) 132, a packet core network 140 that further comprises one or more serving gateway (SGW) 142 and at least one packet data network gateway (PDNGW) 144, a policy enforcement point (PEP) 150 and a policy controller (PC) 160. The PEP 150 and the PC 160 are nodes connected by use of a Gx interface 170, as defined in 3^{rd} generation partnership project (3GPP) specifications. The eNodeB 132 is responsible for radio communications from end-user terminals. The SGW 142 is a router located in a local domain of the UE 110 and directly interfaces with the eNodeB 132. The SGW 142 acts as an inter radio access mobility anchoring for a user plane. The PDNGW 144 is a router located in a home domain of the UE 110 and directly interfaces with the SGW 142. The PDNGW 144 is responsible for allocating Internet Protocol (IP) addresses for user terminals and plays a role as an anchoring point for mobility across various radio access types. The UE 110 and the eNodeB 132 are connected by use of a 3GPP-defined air interface. Interconnection between other elements of the network 100 is generally by use of wired links, also using protocols defined by the 3GPP.

The PEP 150 acts as a policy center for the network. It interacts with the PC 160 over the Gx interface 170 in order to obtain therefrom policies that are applied on a session of the UE 110. Such policies are applied both to management of a radio bearer between the UE 110 and the eNodeB 132 and to management of a service data flow between the UE 110 and the service network 120.

When receiving a first packet originated at or intended to be sent to the UE 110, the PEP 150 obtains profile information of a subscriber using the UE 110, and assigns to the subscriber a policy profile obtained from the PC 160 via the Gx interface 170. This profile defines a behavior of the network 100 for a session being associated with the UE 110.

The PEP 150 needs to continuously rely on the PC 160 to rapidly obtain, upon request, an updated policy profile. This may be become necessary for example when congestion occurs or when the UE 110 makes request for a change of resource. In case of sudden change impacting allocation of resources for the UE 110, the PEP 150 requests an update of the policy profile from the PC 160. However, there is generally a delay in obtaining this update. Temporarily, the PEP 150 becomes unaware of a precise, updated policy profile that would be required in order to properly handle the session. During this time period, QoS for the session may be negatively impacted due to the lack of correct policies. As a result, service performance as perceived by the subscriber may be degraded. Such a situation may get even worse in case of a failure or overload on the PC 160 or on the Gx interface 170. The PEP 150 may become unaware, for an extended period, of the correct policy profile for the UE 110.

FIG. 2 shows a prior art sequence diagram for obtaining a policy applicable upon congestion in a service network. A sequence of events essentially involves the PEP 150, having some interactions with the PC 160 by use of signaling over the Gx interface 170 (shown on FIG. 1). In a first step 210, a session has earlier been established for support of the UE 110 and a policy profile has been acquired by the PEP 150 for handling the session. At step 220, congestion occurs in the network 100. The PEP 150 sends, at step 230, a request to the PC 160 for obtaining, for the UE 110, an updated policy profile appropriate for the new congestion state. Steps 240a and 240b occur in parallel: While the PC 160 prepares a response to the profile request, at step 240b, the PEP 150 continues applying the previously acquired policy profile to the UE session, at step 240a. Eventually, the PC 160 sends the requested policy profile at step 250, and the PEP 150 starts applying the newly received policies at step 260.

A time duration between steps 230 and 250 may vary considerably, especially if there is congestion on the Gx interface 170 or in the PC 160. Regardless, given the high data rates that are offered to user terminals in current networks such as network 100, a fair amount of data payload may be transited to or from the UE 110, possibly with poor QoS, even if the duration of steps 240a and 240b is brief. Communication with the UE 110 may be significantly impaired.

### SUMMARY

There would be clear advantages of having a method and a network node for handling session state transitions while an exact policy for a new session state is not available.

It is therefore a broad object of this invention to provide a method and a node for applying policies to a session having a change of state.

A first aspect of the present invention is directed a method of applying policies to a service session. The method comprises a first step of predicting, in a policy enforcement point, a state of the session. The policy enforcement point then sends the predicted state to a policy controller. In response, the policy enforcement point receives a policy for the predicted state from the policy controller. When the policy enforcement point detects an occurrence of an actual state similar to the predicted state, it applies the policy for the predicted state to the session.

A second aspect of the present invention is directed to a policy enforcement point for applying policies to a service session. The policy enforcement point comprises an interface, a processor and a controller. The interface is for communicating with a policy controller. The processor acts as a prediction engine and is configured to analyze session states. The controller controls the other elements of the policy enforcement point. It obtains from the processor a predicted state for the session. It then requests the interface to send the predicted state towards the policy controller. After a policy for the predicted state has been received through the interface, the controller detects an occurrence of an actual state similar to the predicted state and applies the policy for the predicted state to the session.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a prior art representation of an access and service network architecture;

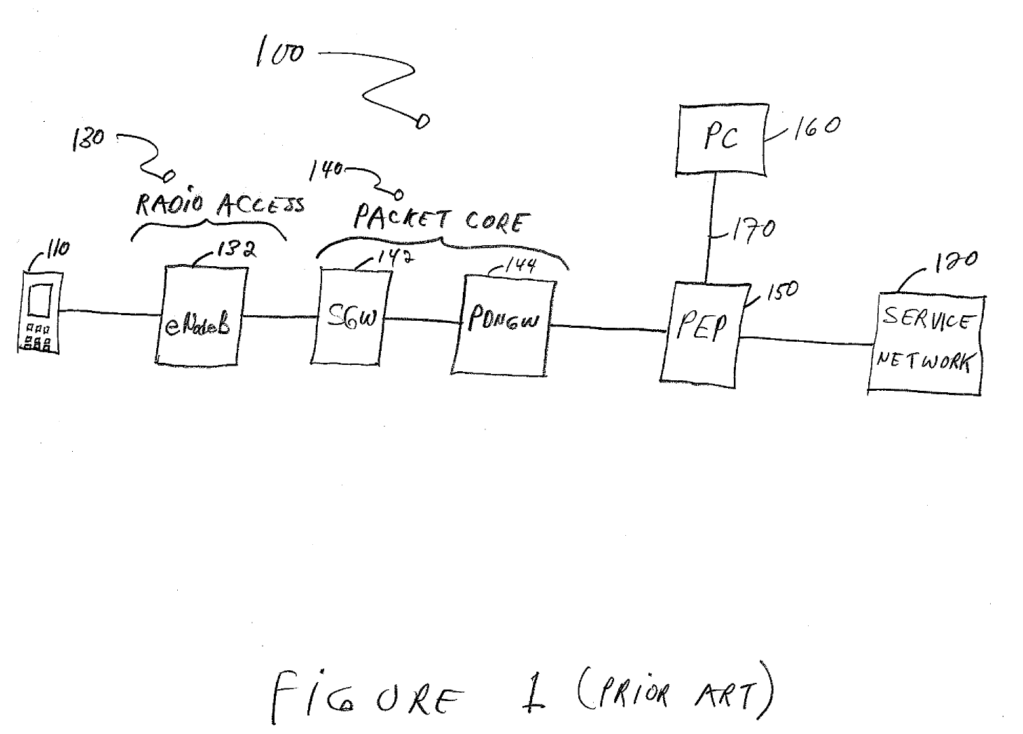

FIG. 2 shows a prior art sequence diagram for obtaining a policy applicable upon congestion in a service network;

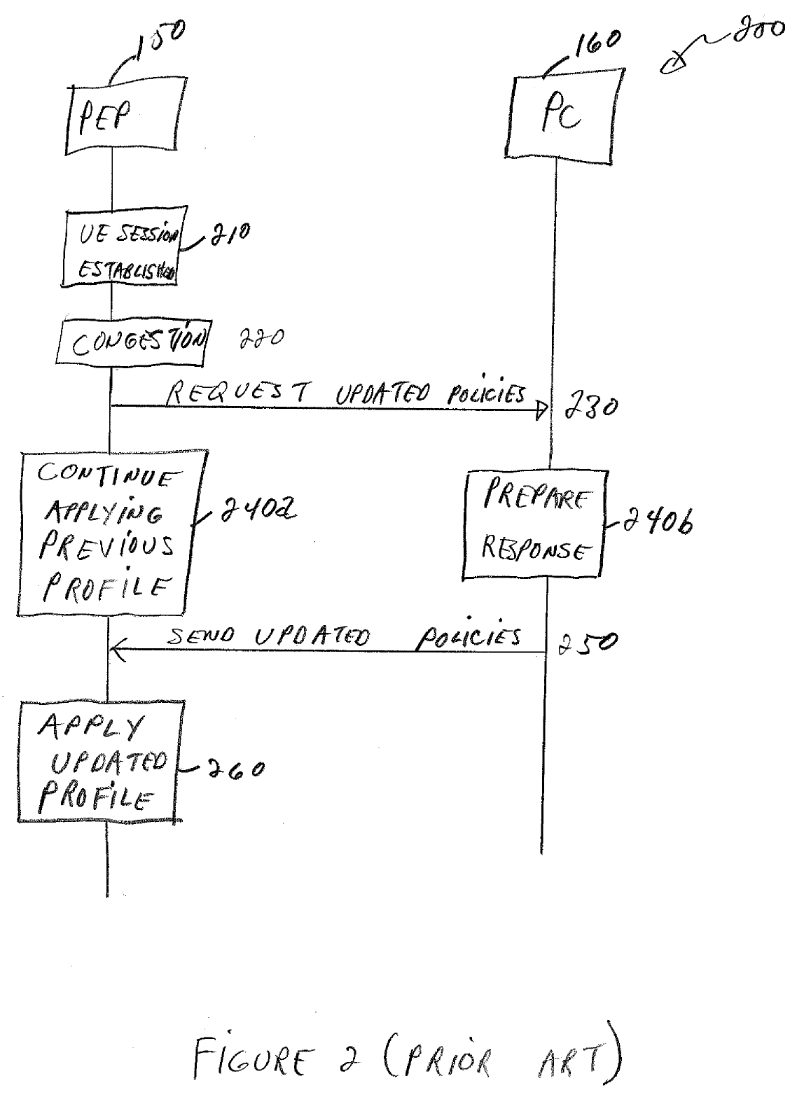

FIG. 3 shows an exemplary method of applying policies to a previously predicted state according to the present invention;

FIG. 4 shows a sequence diagram depicting exemplary steps of a method of applying policies according to the present invention;

FIG. 5 is a flowchart illustrating an algorithm of a prediction engine; and

FIG. 6 shows a policy enforcement point according to an aspect of the present invention.

### DETAILED DESCRIPTION

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the description of the figures, like numerals represent like elements of the invention.

The present invention provides a method and a policy enforcement point (PEP) for providing a temporary policy, or a set of temporary policies, to be applied to a session that is going through a change of state, while an actual policy applicable to the changed state is temporarily unavailable. The PEP coordinates a session established between a user terminal and a service network. The PEP applies policies to the session, but it obtains these policies from a separate node called policy controller (PC), which may also be called a service aware policy controller (SAPC) or a policy and charging rules function (PCRF). The PEP and the PC may communicate through an interface standardized by the 3^{rd} Generation Partnership Project (3GPP), called a Gx interface. When the PEP detects a new state of the session, it sends to the PC a request to obtain policies applicable to the session and for that specific new state. According to the present invention, the PEP makes an ongoing analysis of the session in order to predict future changes to its state. Upon arriving at a prediction for an eventual future state, it sends to the PC a request for a policy (or for a set of policies) for the predicted future state. The PEP stores a response from the PC, the response comprising one or more policies for the predicted state. If the predicted state actually occurs, the PEP is capable of immediately applying the previously stored policies, without having to wait for a response to any new policy request.

In the context of the present invention, a policy enforcement point may comprise a policy control engine (PCE), a policy charging enforcement function (PCEF), a service aware support node (SASN), and the like. The present invention may be used in support of a user terminal having a connection with a service network by use of a 4^{th} generation (4G) mobile radio access, a wireless location area network (WLAN) access, a WiMAX connection, a fixed connection using Ethernet, a cable modem or a fiber, and the like.

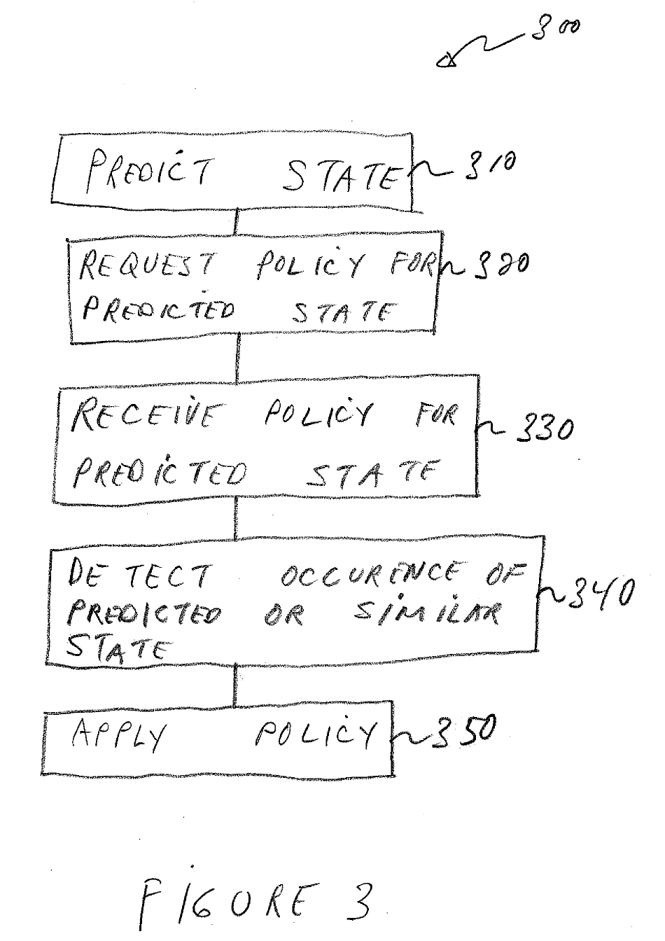

Reference is now made to the Drawings, in which FIG. 3 shows an exemplary method of applying policies to a previously predicted state according to the present invention. A sequence 300 is used, for example in a node called a policy enforcement point, to apply an appropriate policy to a session when a state of the session changes. At step 310, a future state of the session is predicted. Given a current state of the session, the future state may for example be representative of an eventual congestion event occurring within the session. Alternatively, the future state may result from an eventual change of a bearer allocated to a user of the session, the bearer change possibly resulting from a handoff of the session from a cell to a new target cell. In other cases, the future state may result from a change of the manner in which a data flow behaves within the session, because of a change of service type or service characteristic provided to the user. Depending on the nature of the session and on the service provided by the session, other future changes to the state of the session may be predicted. At step 320, a policy for the predicted state is requested. A network element making the state prediction may request the policy for the predicted state from another network element responsible for allocating policies. At step 330, the policy for the predicted state is obtained. The predicted state, or a similar state, may actually occur and be detected at step 340. Responsive to the detection, the policy obtained from the prediction of the state, which has now occurred, is applied to the session at step 350.

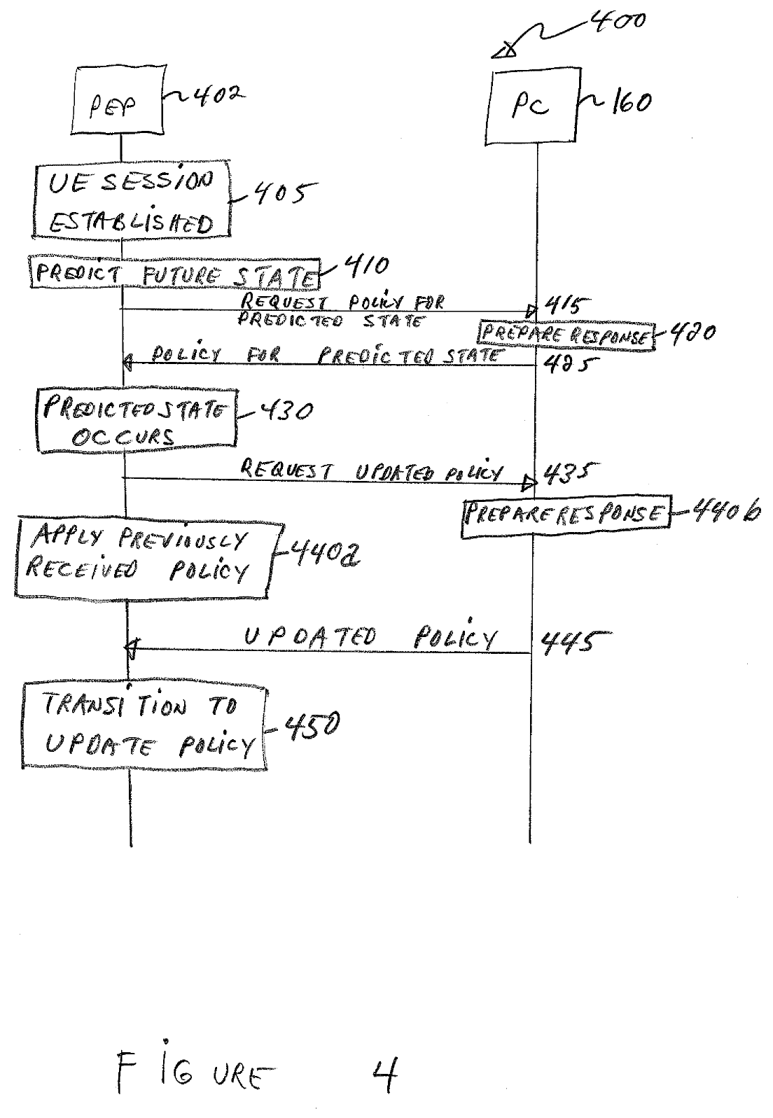

A more detailed understanding of various aspects of the present invention may be obtained from FIG. 4, which shows a sequence diagram depicting exemplary steps of a method of applying policies according to the present invention. A sequence 400 takes place on a Gx interface (not shown), between a policy enforcement point (PEP) 402 and a policy controller (PC) 160. The PEP 402 differs from prior art nodes at least by means of addition of some of the steps of the sequence 400. The PC 160 may comply with prior art policy controllers.

At step 405, a session for a user equipment (UE) is established at the PEP 402. The PEP 402 predicts a possible future state of the UE session at step 410. The prediction may be based, for example, on heuristic pattern analysis and recognition. Further exemplary details of how the prediction is made at step 410 are presented hereinbelow. At step 415, the PEP 402 sends towards the PC 160 a request for one or more policies for the UE, based on the predicted state. In the context of the present invention, a single policy or a complete set comprising a plurality of policies may be applied to the UE session. The term “policy” is used herein in the singular form for the purpose of simplifying the present description of the various steps of the sequence 400; those skilled in the art will readily recognize that the term “policy” as used in the present description may encompass any number of policies for the UE session. The PC 160 prepares a response to the request at step 420 and sends the policy for the predicted state at step 425. A delay may occur between the steps 415 and 425, but that delay is inconsequential inasmuch as a present state of the UE session does not significantly change between these steps. At some time thereafter, at step 430, an event changes the state of the UE session and the PEP 402 detects, in that changed state, an occurrence of the state that has been predicted at step 410. Those skilled in the art will understand that step 430 may comprise detecting an actual state that is the same or that is similar to the predicted state. For example, an actual congestion event may be slightly more or less severe than the one that was predicted. Likewise, an actual bearer change may result from a handoff towards a new cell that is distinct from the expected target cell. A data flow behavior change may imply a slightly different set of QoS characteristics than those predicted. Regardless, step 430 is to be understood as a detection of an actual state that is sufficiently similar to the predicted state for the policy for the predicted state to be useful as applied to the UE session, given the actual state. Responsive to the detection, the PEP 402 sends to the PC 160 a new request for an updated policy, at step 435, based on the actual session state. While the PC 160 prepares a response at step 440b, the PEP 402 begins applying at step 440a, to the UE session, the policy received at step 425. The PC 160 eventually sends the updated policy to the PEP 402 at step 445. The PEP 402 makes, at step 450, a transition of its handling of the UE session from the policy received at step 425, which was based on a predicted state, to the updated policy received at step 445, which is based on an actual state. In some embodiments, the transition of the UE session handling may be gradual from the policy for the predicted state towards the updated policy. For example, if the updated policy requires a bandwidth reduction, this reduction may be applied gradually in order to reduce disruption of the service.

More details on possible embodiments of some of the steps of the sequence 400 are provided hereinbelow. In some embodiments, predicting a future state for the UE session at step 410 may be implemented by use of a Kalman filter. The Kalman filter is a well-known time domain filter that performs a point-by-point analysis to estimate future states in a dynamic system subjected to random (noise-like) inputs. An estimated state for a current time step and a current variable input are used to compute an estimate for a next state. The Kalman filter uses an assumption for a variance of the state and a correlation coefficient between consecutive states and the variable input. Thus, the Kalman filter may analyze inputs related to a capacity and load on an evolved node B (eNodeB) providing access to a user terminal and predict an eventual congestion event. The Kalman filter may alternatively analyze inputs related to handoff processes at the eNodeB and predict a bearer change. The Kalman filter may also analyze inputs related to the service and predict that more or less bandwidth may soon be required for the session, for example as a result of a video or audio codec change. In other embodiments, the predicting step 410 may use various neural network algorithms, instead of the Kalman filter. It is also possible to perform manual state prediction based on the time of day, on the geographical located of a serving eNodeB, etc.

The prediction process of step 410 may run in the background within the PEP 402 in order to continuously be capable of supplying a predicted state for the service session. For this purpose, the Kalman filter may be associated with the service session initially upon session set-up, for example as a part of step 405, and may continuously improve its state prediction. Consequently, the steps 410-425 of FIG. 4 may be repeated on an ongoing basis in order to provide the PEP 402 with an up-to-date prediction of a likely future state that may occur at step 430.

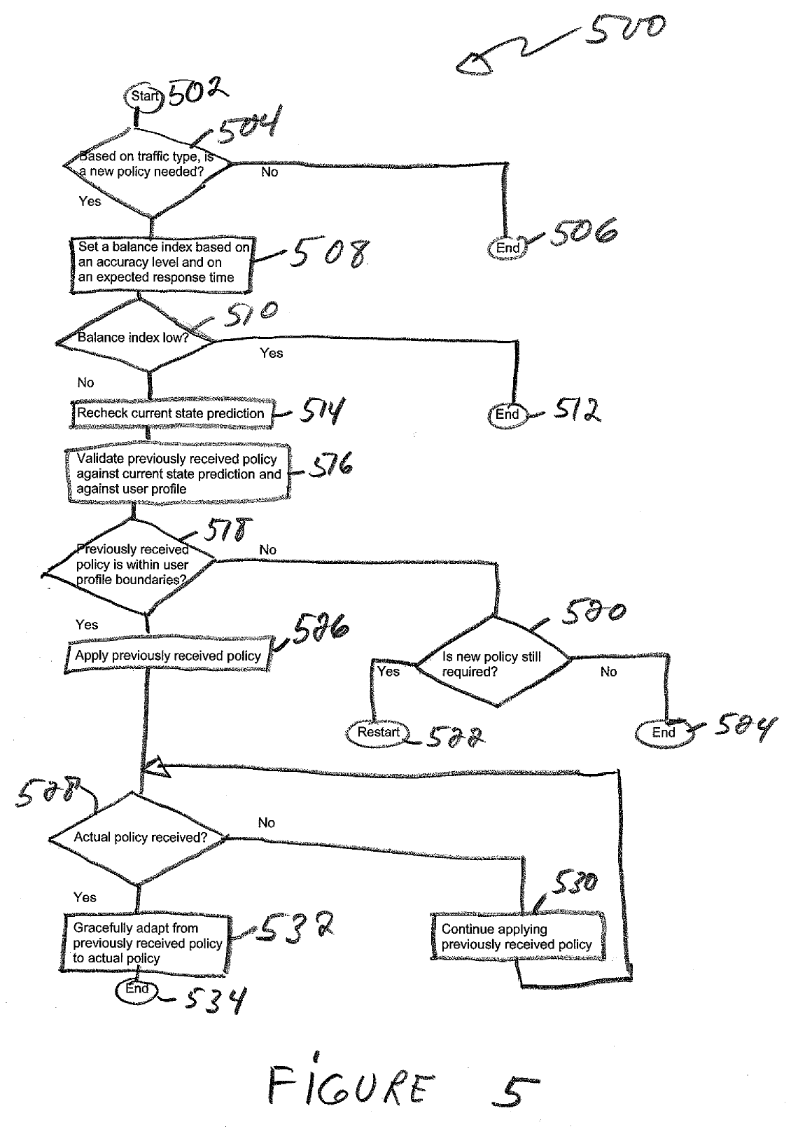

FIG. 5 is a flowchart illustrating an algorithm of a prediction engine. The prediction engine may be implemented in a policy enforcement point such as the PEP 402, and is especially designed for fulfilling some of the steps of sequence 400. The method, which as illustrated comprises several optional steps, starts at step 502 when it may be determined within the PEP 402 that adaptation of a UE session may be required. Step 502 may generally coincide with or shortly follow step 430 of sequence 400. At step 504, the prediction engine determines whether or not a new policy may be needed. For example, if the UE session is for a best-effort packet data service, QoS requirements may have little relevance and it may not be required to update a policy for the UE session. In that case, the sequence ends at step 506. If step 504 determines that a new policy may be helpful, a balance index may be determined at step 508. The balance index is based on an accuracy level for the policy setting and on an expected response time in obtaining the policy setting. Given that the policy enforcement point, which incorporates the prediction engine and the sequence 500, may be serving a potentially large number of user terminal sessions, the balance index is useful in prioritizing for which sessions it may be worthwhile to try and obtain up-to-date policies. If the response time is expected to be high while the UE session does not require a high accuracy for its policies, the balance index is determined to be low at step 510 and the sequence ends at step 512. If the balance index at step 510 is not low, either because the expected response time is short or because highly accurate policies are needed for the UE session, the process continues at step 514. As mentioned in the foregoing description of the step 410 of FIG. 4, the prediction process may be continuously running in the background. At step 514, a current and more accurate value of the state may be obtained from the prediction process. The sequence may optionally comprise a step 516 of validating the previously received policy, obtained for a predicted state in the sequence 400 of FIG. 4, against the current state determined at step 514. In step 516, the previously received policy may also be validated against a subscriber profile for the session. At step 518, it may be determined whether the previously received policy conforms to the subscriber profile. If, for example, the previously received policy suggests a bandwidth level that exceeds a limit set in the subscriber profile, the determination of step 518 is negative. If so, the sequence 500 continues at step 520 where it is determined whether or not continuation of the session still requires an updated policy. If so, the sequence restarts at step 522, implying a new execution of the sequence 500 starting at step 502. If an updated policy is no longer required, the sequence 500 ends at step 524. Returning to the determination of step 518, if the previously received policy is acceptable and matches the subscriber profile, the process continues at step 526 where the previously received policy starts being applied to the session. Step 526 generally coincides with step 440a of FIG. 4. While not shown on FIG. 5, the step 435 of sending the new request for an updated policy, as shown on FIG. 4, also takes place following step 518. Step 528 illustrates an ongoing verification of whether or not an actual policy is received at the policy enforcement point. If not, the previously received policy continues being applied at step 530. If step 528 determines that a new policy is received, corresponding to the step 445 of FIG. 4, the process continues at step 532 where the session transitions from the previously received policy to the new, actual policy. The transition may be gradual in order to mitigate a possible disruption of the session as experienced by the user.

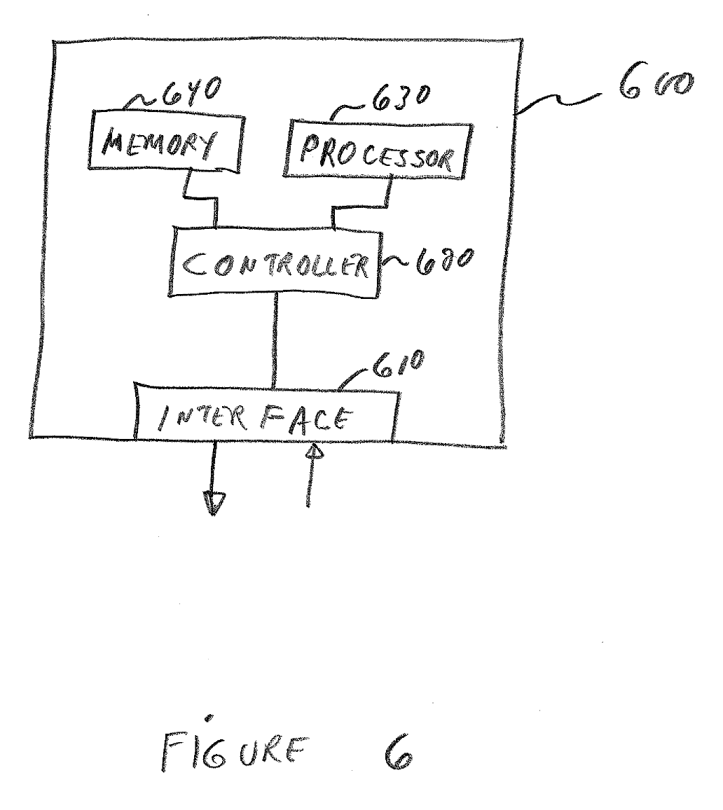

An exemplary construction of a policy enforcement point will now be described by reference to FIG. 6, which shows a policy enforcement point according to an aspect of the present invention. A policy enforcement point 600 comprises an interface 610, a controller 620, and a processor 630, and may further comprise a memory 640. The memory 640 may be a volatile memory, or may alternatively be a non-volatile memory, or persistent memory, that can be electrically erased and reprogrammed and that may be implemented, for example, as a flash memory or as a data storage module. The controller 620 and the processor 630 may be distinct components of the policy enforcement point 600, or may be integrated as a single processing component. They may both be any commercially available, general purpose processor, or may be specifically designed for operation in the policy enforcement point 600. The controller 620 and the processor 630 may be operable to execute processes related to the present invention in addition to numerous other processes. The interface 610 may be implemented as one single device or as distinct devices for receiving and sending signaling, messages and data. The policy enforcement point 600 is connected towards at least one policy controller, at least one service network and at least one packet core network; means for connecting the policy enforcement point 600 towards these various nodes may vary as, for example, connection towards one policy controller might be on an Ethernet link while connection towards a service network might be on an asynchronous transfer mode (ATM) link. Therefore the interface 610 may comprise a plurality of devices for connecting on a plurality of links of different types. Only one generic interface 610 is illustrated for ease of presentation of the present invention. The policy enforcement point 600 may be a policy and charging enforcement function (PCEF). The policy enforcement point 600 may further act as a router and may thus comprise many more components, as is well-known in the art.

In operation, the policy enforcement point 600 manages a session established between a user terminal having a session and a service network. Data exchanged between the user terminal and the service network arrives at the interface 610 and is treated by the controller 620, according to one or more policies assigned to the session, prior to forwarding to its intended destination. The policies are obtained from a separate node, generally a policy controller such as a service aware policy controller or a policy charging rules function. The policies arrive at the interface 610, which in turn presents them to the controller 620. The controller 620 may store the policies in the memory 640. Upon request from the controller 620, or in a continuous fashion, the processor 630 analyzes a flow of the data and other network conditions in order to detect events that may impact a state of the session. The processor 630 thus acts as a prediction engine that provides a predicted state to the controller 620. For making its prediction, the processor 630 may comprise a Kalman filter. The controller 620 requests the interface 610 to send the predicted state towards the policy controller. The controller 620 then receives through the interface 610 a policy, or a set of policies, for the predicted state.

The policy for the predicted state may be stored in the memory 640 by the controller 620. The state of the session may change and a new, actual state may be detected by the controller 620. If the actual state is the same as or is similar to the predicted state, the controller 620 applies the policy for the predicted state to the session.

As the state of the session may be continuously varying, the actual state may not be exactly the same as the predicted state. Moreover, the actual state at any given time may change to a new, actual state. The controller 620 thus requests the interface 610 to send the actual state towards the policy controller. In waiting for a response, the controller 620 continues applying the policy for the predicted state to the session. Upon receiving a policy for the actual state through the interface 610, the controller 620 starts applying that policy to the session. The controller 620 may gradually adapt its handling of the session from the policy for the predicted state to the policy for the actual state. In addition to the features described in relation to FIG. 6, the policy enforcement point may be capable of performing the features of the various embodiments of the policy enforcement point presented in FIGS. 3, 4 and 5.

Although several aspects of the preferred embodiment of the method, and of the policy enforcement point of the present invention have been illustrated in the accompanying Drawings and described in the foregoing Detailed Description, it will be understood that the invention is not limited to the embodiments disclosed, but is capable of numerous rearrangements, modifications and substitutions without departing from the teachings of the invention as set forth and defined by the following claims.

1. A method, implemented in a policy enforcement point, of applying policies to a service session, the method comprising the steps of:
predicting, in the policy enforcement point, a state of the session;
sending, from the policy enforcement point to a policy controller, the predicted state;
receiving, at the policy enforcement point from the policy controller, a policy for the predicted state;
detecting, at the policy enforcement point, an occurrence of an actual state similar to the predicted state; and
applying, at the policy enforcement point, the policy for the predicted state to the session.

2. The method of claim 1, wherein:
the step of predicting the state of the session comprises using a Kalman filter.

3. The method of claim 1, further comprising the steps of:
after the step of detecting, sending, from the policy enforcement point to the policy controller, the actual state;
responsive to sending the actual state, receiving, at the policy enforcement point from the policy controller, a policy for the actual state; and
applying, at the policy enforcement point, the policy for the actual state to the session.

4. The method of claim 3, wherein:
the policy enforcement point sets an accuracy level to the policy setting and an expected response time before sending the actual state; and
the step of sending the actual state is conditional to a high ratio of the accuracy level over the expected response time.

5. The method of claim 3, wherein:
the policy for the predicted state is applied starting from the step of detecting until the step of receiving the policy for the actual state.

6. The method of claim 3, wherein:
the step of applying the policy for the actual state comprises gradually modifying handling of the session from the policy for the predicted state to the policy for the actual state.

7. The method of claim 1, wherein:
the predicted state is selected from the group consisting of a congestion state, a bearer change state, and a data flow behavior change state.

8. The method of claim 1, wherein:
the policy enforcement point is a policy and charging enforcement function (PCEF) node; and
the policy controller is a policy and charging rules function (PCRF) node.

9. The method of claim 1, further comprising the step of:
validating, at the policy enforcement point, the policy for the predicted state against a subscriber profile for the session; and
wherein the step of applying the policy for the predicted state to the session is conditional to the policy for the predicted state matching the subscriber profile.

10. The method of claim 1, further comprising the step of:
storing, in the policy enforcement point, the predicted state in relation with the received policy for the predicted state.

11. A policy enforcement point for applying policies to a service session, comprising:
an interface configured to communicate with a policy controller;
a processor configured to analyze session states; and
a controller to control the interface and the processor and configured to:
obtain from the processor a predicted state for the session;
request the interface to send the predicted state towards the policy controller;
receive from the interface a policy for the predicted state;
detect an occurrence of an actual state similar to the predicted state; and
apply the policy for the predicted state to the session.

12. The policy enforcement point of claim 11, wherein:
the processor is further configured to apply a Kalman filter for predicting the state of the session.

13. The policy enforcement point of claim 11, wherein the controller is further configured to:
following detection of the actual state, request the interface to send towards, the policy controller, the actual state;
receive from the interface a policy for the actual state; and
apply the policy for the actual state to the session.

14. The policy enforcement point of claim 13, wherein:
the processor is further configured to set an accuracy level to the policy setting and an expected response time before sending the actual state; and
sending the actual state is conditional to a high ratio of the accuracy level over the expected response time.

15. The policy enforcement point of claim 13, wherein the controller is further configured to:
apply the policy for the predicted state starting from the detection of the actual state occurrence until the reception of the policy for the actual state.

16. The policy enforcement point of claim 13, wherein:
applying the policy for the actual state comprises gradually modifying handling of the session from the policy for the predicted state to the policy for the actual state.

17. The policy enforcement point of claim 11, wherein:
the predicted state is selected from the group consisting of a congestion state, a bearer change state, and a data flow behavior change state.

18. The policy enforcement point of claim 11, wherein:
the policy enforcement point is a policy and charging enforcement function (PCEF) node; and
the policy controller is a policy and charging rules function (PCRF) node.

19. The policy enforcement point of claim 11, wherein the controller is further configured to:
validate the policy for the predicted state against a subscriber profile for the session; and
conditionally apply the policy for the predicted state if it matches the subscriber profile.

20. The policy enforcement point of claim 10, further comprising:
a memory for storing a state in relation with a corresponding policy; and
wherein the controller is further configured to store in the memory the predicted state and the received policy for the predicted state.
